(19) United States
(12) Patent Application Publication
(10) Pub. No.: US 2026/0211547 A1
(43) Pub. Date: Jul. 23, 2026

(54) INFORMATION PROCESSING SYSTEM, SETTING SCREEN GENERATING METHOD, AND NON-TRANSITORY COMPUTER-READABLE RECORDING MEDIUM

(71) Applicant: Konica Minolta, Inc., Tokyo (JP)

(72) Inventor: Kazuki Tsurumi, Tokyo (JP)

(73) Assignee: Konica Minolta, Inc., Tokyo (JP)

(21) Appl. No.: 19/409,219

(22) Filed: Dec. 4, 2025

(30) Foreign Application Priority Data
Jan. 22, 2025 (JP) 2025-008910

(51) Int. Cl. G06F 3/04847; G06F 40/268; G06F 40/289; H04N 1/00

(52) U.S. Cl. CPC G06F 3/04847; G06F 40/268; G06F 40/289; H04N 1/00395; H04N 1/00503; H04N 1/0097; H04N 1/00244; H04N 2201/0094

(57) ABSTRACT

An information processing system includes a hardware processor. The hardware processor enters a user's request for settings as text, detects the user's request based on the text, specifies a setting item to be set by the user from among a plurality of setting items in accordance with the user's request, generates a setting screen on which an input form corresponding to the specified setting item is arranged, and provides the generated setting screen.

### CROSS REFERENCE TO RELATED APPLICATIONS

The present application is based on Japanese Patent Application No. 2025-008910 filed on Jan. 22, 2025, the contents of which are incorporated herein by reference.

### BACKGROUND OF THE INVENTION

### Technical Field

The present invention relates to an information processing system, a setting screen generating method, and a non-transitory computer-readable recording medium.

### Description of Related Art

In recent years, functions of an information processing apparatus such as an MFP (Multifunction Peripheral) have been complicated. In order to set each function of the information processing apparatus to a desired state, the user needs to perform a setting operation for many setting items. For example, the user needs to appropriately input a desired setting value for a necessary setting item included in each setting screen while sequentially displaying a plurality of setting screens having a hierarchical structure. However, it is difficult for the user to appropriately perform a setting operation for many setting items over a plurality of setting screens, and setting omission or a setting mistake is likely to occur.

Conventionally, a technique has been proposed that allows a user to easily and appropriately set a plurality of setting items required to attain a predetermined setting state. For example, in the related art disclosed in Japanese Unexamined Patent Publication No. JP2021-111147A, a plurality of setting items necessary for a predetermined setting state are specified, and a setting guidance screen in which links to screens for displaying the setting items are arranged in order according to a setting order is displayed. Therefore, by sequentially operating the links displayed on the setting guidance screen, the user can sequentially display screens including necessary setting items and proceed with the setting operation.

However, even if a screen including a setting item that is required for setting is displayed by operating a link, the screen may include a setting item that requires a setting operation and a setting item that does not require a setting operation. In this case, it is difficult for the user to distinguish between a setting item for which a setting operation is necessary and a setting item for which a setting operation is unnecessary. Thus, it takes a long time to complete all settings, and a setting omission or a setting error may still occur.

Incidentally, in recent years, for the purpose of improving user operability, there has been provided an information processing apparatus that displays a wizard format setting screen on which a setting operation can be performed in an interactive manner. The wizard format setting screen supports the user so that incorrect selection or setting omission does not occur in the process of operation. Therefore, the user can easily realize a predetermined setting state by proceeding with the operation based on the instruction from the setting screen.

However, with the complication of functions, users'demands for information processing apparatuses have diversified. Therefore, it is difficult to prepare in advance the setting screen in the wizard format corresponding to all the diversified demands of the user.

### SUMMARY OF THE INVENTION

The present invention has been devised in order to solve the above-described conventional problems. That is, an object of the present invention is to provide an information processing system, a setting screen generating method, and a non-transitory computer-readable recording medium, which are capable of easily creating a setting screen on which a setting omission or a setting error is less likely to occur, in order to easily perform setting according to a user's request.

One subject of the present invention is directed to an information processing system. According to an aspect of the present invention, the information processing system includes a hardware processor. The hardware processor enters a user's request for settings as text, detects the user's request based on the text, specifies a setting item to be set by the user from among a plurality of setting items in accordance with the user's request, generates a setting screen on which an input form corresponding to the specified setting item is arranged, and provides the generated setting screen.

### BRIEF DESCRIPTION OF THE DRAWINGS

The advantages and features provided by one or more embodiments of the invention will become more fully understood from the detailed description given herein below and the appended drawings which are given by way of illustration only, and thus are not intended as a definition of the limits of the present invention.

FIG. 1 is a diagram illustrating an example of a configuration of an information processing system;

FIG. 2 is a block diagram illustrating a hardware configuration of an information processing apparatus;

FIG. 3 is a diagram illustrating an example of the configuration of screen information;

FIG. 4 is a diagram illustrating an example of the configuration of an input form;

FIG. 5 is a diagram illustrating an example of a data structure of a setting item database;

FIG. 6 is a diagram illustrating an example of category detailed information;

FIG. 7 is a view illustrating an example of the top screen;

FIG. 8 is a block diagram illustrating an example of the configuration of a controller;

FIG. 9 is a diagram illustrating an initial screen;

FIG. 10A, FIG. 10B, FIG. 10C, and FIG. 10D are diagrams illustrating a configuration example and an operation example of a setting item identifying section;

FIG. 11 is a diagram illustrating another configuration example of the setting item identifying section;

FIG. 12 is a diagram illustrating an example of a selection screen;

FIG. 13A and FIG. 13B are diagrams illustrating a setting screen generated for SMB server setting;

FIG. 14 is a flowchart illustrating an example of a processing procedure in the information processing system;

FIG. 15 is a flowchart illustrating a specific processing procedure of setting category identification processing; and

FIG. 16 is a flowchart illustrating an example of a detailed processing procedure of the screen generation processing.

### DETAILED DESCRIPTION OF EMBODIMENTS

Hereinafter, one or more embodiments of the present invention will be described with reference to the drawings. However, the scope of the invention is not limited to the disclosed embodiments. Note that in the embodiments described below, common elements are denoted by the same reference signs, and redundant description thereof is omitted.

### Example Configuration of Information Processing System

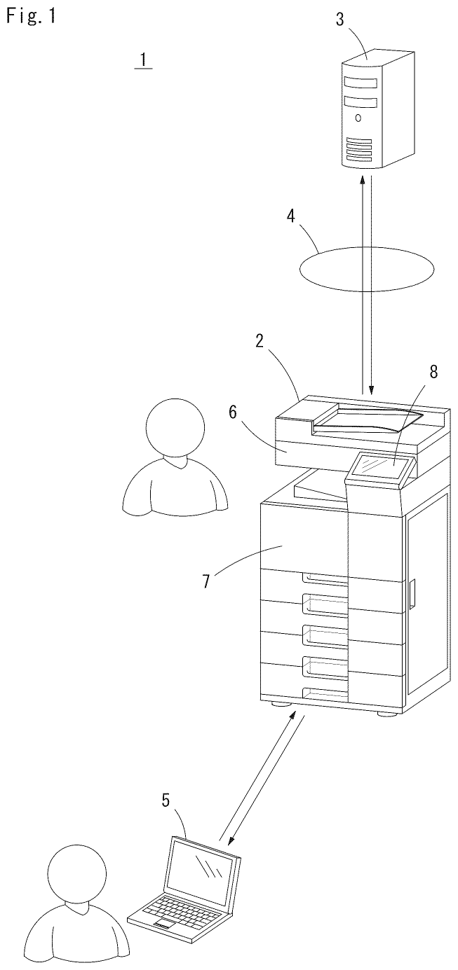

FIG. 1 illustrates an example of the configuration of an information processing system 1 according to an embodiment of the present invention. The information processing system 1 includes an information processing apparatus 2, a server device 3, and a terminal device 5. The information processing apparatus 2 and the server device 3 are communicable with each other via a network 4. The network 4 includes a local network such as a LAN (Local Area Network) and the Internet. The information processing apparatus 2 can also communicate with the terminal device 5. The communication between the information processing apparatus 2 and the terminal device 5 may be wired communication or wireless communication, and may be performed via the network 4.

The information processing apparatus 2 is constituted by an MFP, for example. The information processing apparatus 2 includes a scanner unit 6, a printer unit 7, and an operation panel 8. The scanner unit 6 generates image data by reading an image of a document set by a user. The printer unit 7 forms an image on a sheet such as printing sheet and outputs the printed sheet. The operation panel 8 is a user interface for a user to use the information processing apparatus 2.

The operation panel 8 displays various setting screens that can be operated by a user, and receives an operation by the user. The user can set various functions installed in the information processing apparatus 2 to desired states by performing an operation on the operation panel 8.

Furthermore, the information processing apparatus 2 is also capable of transmitting, to the terminal device 5, a setting screen that can be operated by the user, and receiving a user operation via the terminal device 5. For example, the information processing apparatus 2 has a web server function and provides the terminal device 5 with various setting screens to be displayed on the operation panel 8 as web pages. By activating a web browser, the terminal device 5 displays the setting screen provided from the information processing apparatus 2, and receives a user operation. Next, the terminal device 5 transmits an operation signal corresponding to the user's operation to the information processing apparatus 2. Therefore, by operating the terminal device 5, the user can set various functions of the information processing apparatus 2 to desired states.

The information processing apparatus 2 has a plurality of functions. For example, in addition to basic functions such as a copying function, a scanning function, and a printing function, the information processing apparatus 2 has various additional functions. Additional functions of the information processing apparatus 2 may be turned off in an initial state. When the user wants to use an additional function of the information processing apparatus 2, the user needs to perform a setting operation on the information processing apparatus 2 to reflect the setting for enabling the additional function to operate. At this time, the user needs to perform complicated setting according to the installation environment of the information processing apparatus 2 or the like. However, it is difficult for the user to grasp which setting value should be input for which setting item to realize a desired setting.

The server device 3 is a server that assists a user in performing a setting operation on the information processing apparatus 2. For example, the server device 3 is configured as a generative artificial intelligence (AI) server. If the user does not know a setting method for achieving the desired setting, the user inputs, to the information processing apparatus 2, a request indicating how to use the information processing apparatus 2. The information processing apparatus 2 transmits the request inputted by the user to the server device 3. The server device 3 identifies the user's request, and identifies setting items to be set by the user in order to achieve the user's request. Such a function of the server device 3 may be installed in the information processing apparatus 2.

### Example of the Configuration of the Information Processing Apparatus 2

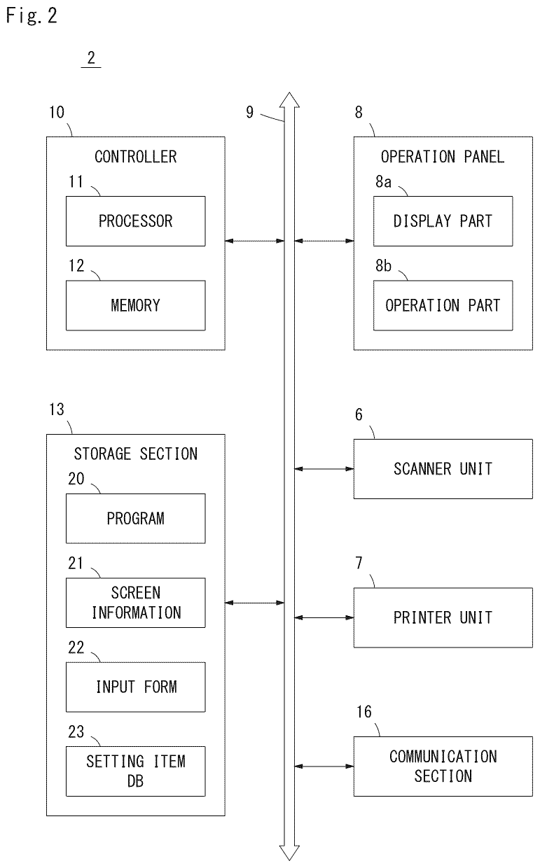

FIG. 2 is a block diagram illustrating a hardware configuration of the information processing apparatus 2. The information processing apparatus 2 includes a scanner unit 6, a printer unit 7, an operation panel 8, a controller 10, a storage section 13, and a communication section 16. The controller 10 is connected to each section via the bus 9, and controls the operation of the information processing apparatus 2.

The operation panel 8 includes a display part 8a and an operation part 8b. The display part 8a is formed of, for example, a color liquid-crystal display, and displays various setting screens. The operation part 8b includes a touch screen or the like disposed on a screen of the display part 8a, and detects a user's operation.

The controller 10 includes a processor 11 and a memory 12. The processor 11 is a hardware processor that controls the operation of each unit by executing a computer-readable program. For example, the processor 11 reads and executes the program 20 stored in the storage section 13. The memory 12 provides a storage area serving as a work area when the processor 11 executes the program 20.

The storage section 13 is a non-volatile storage device constituted by, for example, a hard disk drive (HDD) or a solid state drive (SSD). The storage section 13 stores in advance a program 20 to be executed by the processor 11. Further, the storage section 13 stores screen information 21, an input form 22, and a setting item database 23.

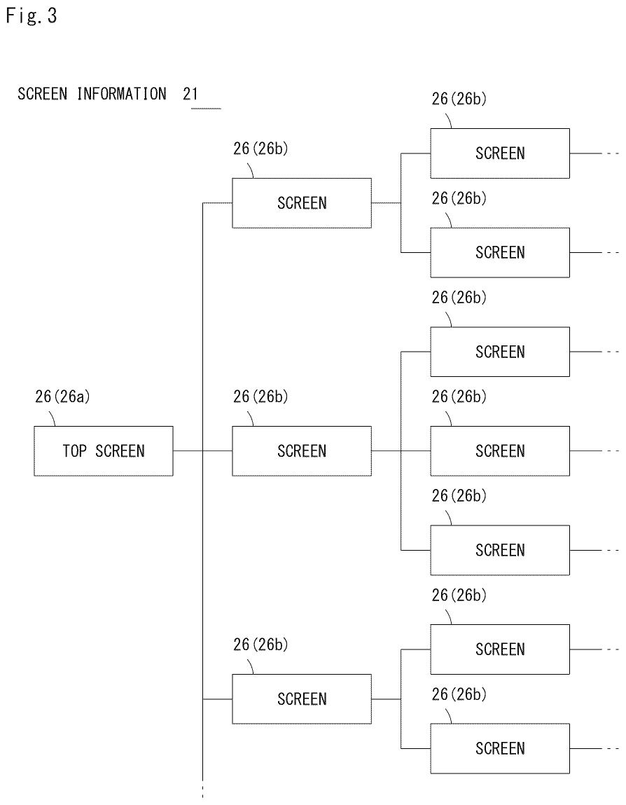

The screen information 21 is information in which a plurality of screens to be displayed on the display part 8a of the operation panel 8 are registered. FIG. 3 is a view illustrating a configuration example of the screen information 21. As illustrated in FIG. 3, a plurality of screens 26 are accumulated in the screen information 21. The plurality of screens 26 form a hierarchical structure, and have a screen configuration in which a top screen 26a at the top is branched into a plurality of sub-screens 26b. Further, the plurality of sub-screens 26b also form a hierarchical structure. The information processing apparatus 2 selects one screen corresponding to the operation of the user from among the plurality of screens 26 and displays it on a display part 8a. That is, the user can set the information processing apparatus 2 to a desired state by performing a setting operation on each screen while changing the screen displayed on the display part 8a. However, it is difficult for the user to perform the setting operation while sequentially displaying only the screens necessary for realizing a desired state among the plurality of screens 26 formed as the hierarchical structure.

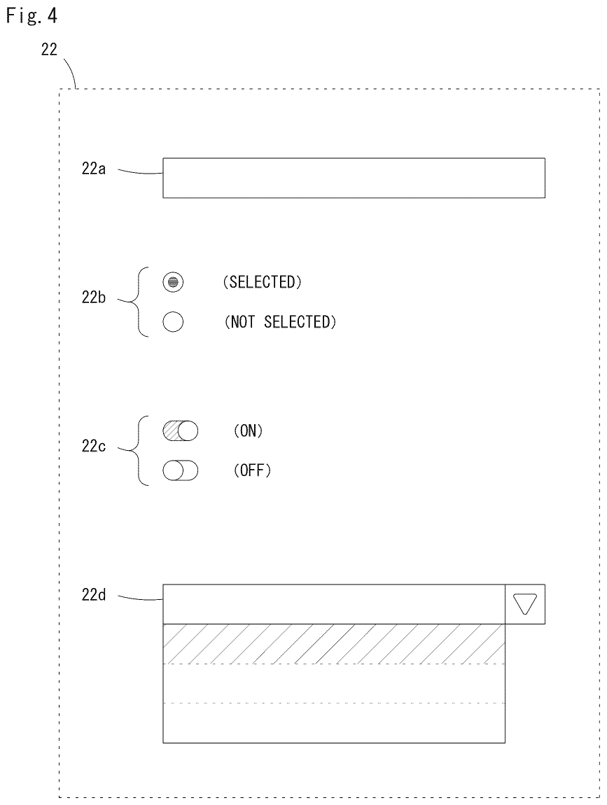

The input form 22 is a screen constituent element arranged on the screen 26, and is an information input part on which a user can perform an input operation. In the input form 22, a plurality of types of forms are registered according to the type of the setting input value or the mode of the input operation. FIG. 4 is a diagram illustrating a configuration example of an input form 22. As illustrated in FIG. 4, the input form 22 includes, for example, a character string input form 22a, radio buttons 22b, a toggle switch 22c, and a pull-down menu 22d. When the screen 26 is displayed on the display part 8a, these input forms 22 are read from the storage section 13 and arranged at designated positions in the screen 26.

The character string input form 22a is a screen constituent element that is displayed when a character string is input. The character string input form 22a is configured as, for example, a rectangular frame in which a character string can be input, and a character string (text) to be input can be displayed inside the rectangular frame. When the character string input form 22a is included in the screen displayed on the display part 8a, the user can input an arbitrary character string (text) to the character string input form 22a.

The radio buttons 22b are screen constituent elements that are displayed when, for example, one of a plurality of options is selected. The radio buttons 22b are displayed for a plurality of options, respectively, and the central dot is turned on when selected and the central dot is turned off when not selected. When a plurality of radio buttons 22b are included in the screen displayed on the display part 8a, the user can select one of the plurality of radio buttons 22b.

The toggle switch 22c is a screen constituent element that is displayed when switching between on and off, for example. The toggle switch 22c is displayed for a setting item that can be switched between on and off, and is switched between on and off by a switching operation by the user. The toggle switch 22c changes a display mode between an on-state and an off-state. Therefore, a user can grasp, from the display manner of the toggle switch 22c, which of the on state and the off state the toggle switch 22c is set to.

Like the radio buttons 22b, the pull-down menus 22d are screen constituent elements that are displayed when, for example, one of a plurality of options is selected. The pull-down menu 22d displays a list of a plurality of options, and when one option is selected from the list, the selected option is displayed in an upper display field. When the pull-down menu 22d is included in the screen displayed on the display part 8a, the user can select one of a plurality of options included in the pull-down menu 22d.

In a case where a setting item that can be set by the user is included in each screen 26 registered in the screen information 21, each screen 26 includes a link to the input form 22 corresponding to the setting item. Therefore, when the information processing apparatus 2 changes the screen to be displayed in the display part 8a based on the screen information 21, the information processing apparatus 2 acquires the input form 22 based on the link to the screen 26 to be displayed, and arranges and displays the acquired input form 22 at a specified position in the screen 26. Thus, the user can perform an input operation on the input form 22.

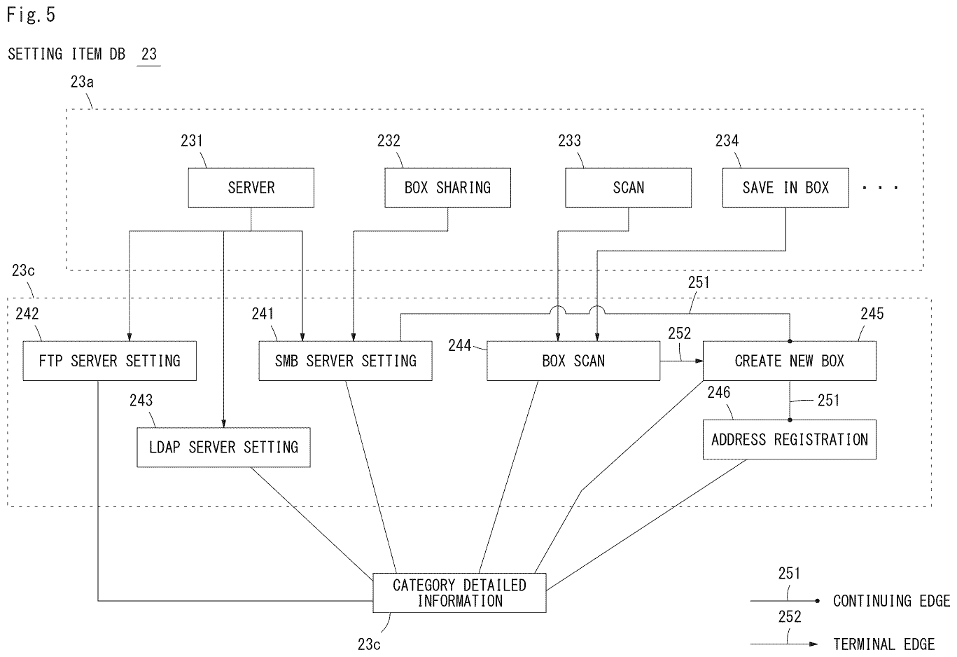

The setting item database 23 is a database in which a relationship between a plurality of setting items that can be set by the user is described. FIG. 5 is a diagram showing an example of a data structure of the setting item database 23. The setting item database 23 includes a keyword area 23a, a setting category area 23b, and a category detail information 23c. In the keyword area 23a, a plurality of keywords 231, 232, 233, and 234 are registered. In the setting category area 23b, a plurality of setting categories 241, 242, 243, 244, 245, and 246 are registered. The setting category is obtained by grouping and categorizing one or a plurality of setting items for each function or theme in the information processing apparatus 2. Therefore, in one setting category, setting items to be set by the user to realize a predetermined state are aggregated with respect to a specific function or theme.

Each of the plurality of keywords 231, 232, 233, and 234 registered in the keyword area 23a is associated with any one of the plurality of setting categories 241, 242, 243, 244, 245, and 246 registered in the setting category area 23b. One keyword may be associated with one setting category or may be associated with a plurality of setting categories. For example, in FIG. 5, a keyword 231 “server” is associated with a plurality of setting categories 241, 242, and 243. A keyword 232 of “BOX sharing” is associated with one setting category 241. Furthermore, the keyword 233 “scan” and the keyword 234 “save in BOX” are associated with the same setting category 244.

The setting categories 241, 242, 243, 244, 245, and 246 registered in the setting category area 23b are associated with each other. For example, when it is necessary to perform setting for another setting category after performing setting for one setting category, the plurality of setting categories are associated with each other in the setting category area 23b. For example, in the setting item database 23 illustrated in FIG. 5, a plurality of setting categories related to each other are linked by two types of edges 251 and 252. An edge 251 is a continuing edge, and indicates that an edge further continuing to another setting category exists. The edge 252 is a terminal edge and represents a connection to a setting category serving as a terminal. Edges 251 and 252 connecting from one setting category to another setting category define a setting order for the plurality of setting categories.

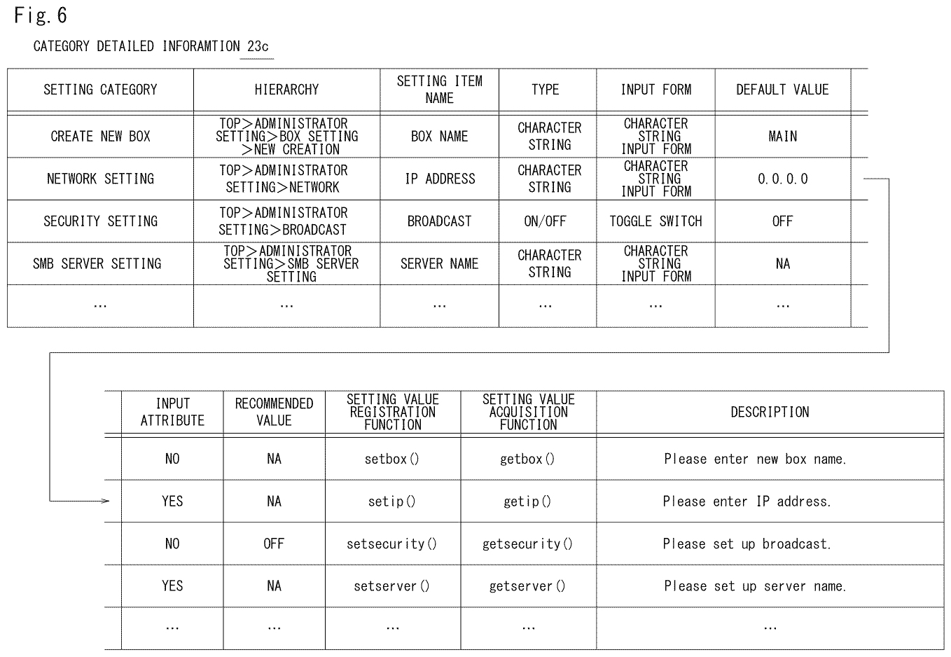

Each of the plurality of setting categories 241, 242, 243, 244, 245, and 246 is associated with the category detailed information 23c. FIG. 6 is a view illustrating an example of category detailed information 23c. The category detailed information 23c is information in which a setting category, a hierarchy, a setting item name, a type, an input form, a default value, an input attribute, a recommended value, a setting value registration function, a setting value acquisition function, and a description are registered.

The setting category registered in the setting category area 23b is described in the setting category. In the hierarchy, a hierarchical structure of the screen 26 including the setting item associated with the setting category is described. The name of the setting item is described in the setting item name. The type defines the type of input data for the setting item. The input form defines a type of the input form 22. The default value is a default value for the setting item. The input attribute indicates whether or not an input operation by the user is necessary. The recommended value defines a recommended value for the setting item. Note that a recommended value might not be defined. The setting value registration function is a function for registering a setting value for the setting item. The setting value acquisition function is a function for acquiring the current setting value of the setting item. The explanation is an explanation for the setting item and is stored as, for example, a text sentence.

Therefore, the setting item database 23 has a data structure in which a setting category can be specified from a keyword and a necessary setting item can be extracted from the specified setting category.

### Initial Screen

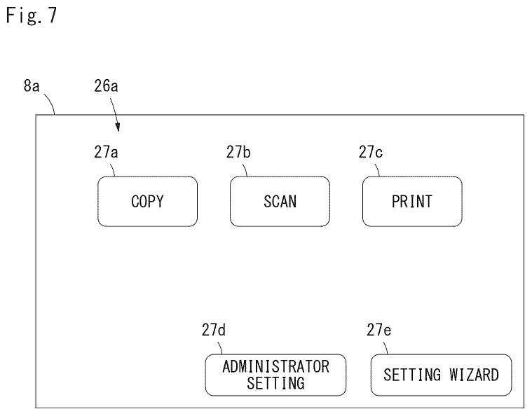

FIG. 7 is a diagram illustrating an example of a top screen 26a displayed on the display part 8a of the information processing apparatus 2. The top screen 26a includes a copy button 27a, a scan button 27b, and a print button 27c. When a user wants to execute a copy job by using the information processing apparatus 2, the user operates the copy button 27a. Then, a setting screen for performing detailed setting related to the copy job is displayed on the display part 8a. The user can perform detailed settings of the copy job by performing an operation on the setting screen. When the scan button 27b or the print button 27c is operated by the user, the information processing apparatus 2 displays a setting screen for detailed setting related to the scan job or the print job on the display part 8a. That is, the copy button 27a, the scan button 27b, and the print button 27c are buttons for displaying sub-screens for setting basic functions of the information processing apparatus 2.

The top screen 26a includes an administrator setting button 27d and a setting wizard button 27e. The administrator setting button 27d is a button for displaying a sub-screen for setting an additional function in the information processing apparatus 2. However, the user does not frequently perform a setting operation for the additional function. Therefore, the user often does not know which setting value to input for which setting item can set an additional function to a desired state. Furthermore, the user often does not grasp in which screen of the hierarchical structure a setting item that needs to be set is included. In such a case, the user operates the setting wizard button 27e. In response to the setting wizard button 27e being operated by the user, the information processing system 1 activates a function to support the user's setting operation, generates a setting screen (wizard screen) on which a setting mistake or a setting omission is unlikely to occur, and provides the user with the setting screen. Details of the information processing system 1 will be described below.

### Configuration of Controller 10

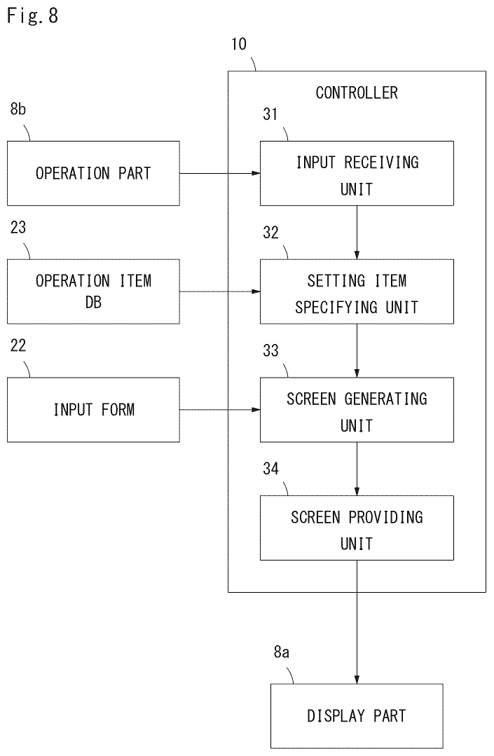

FIG. 8 is a block diagram illustrating a configuration example of the controller 10 in a case where the function of supporting the setting operation of the user operates. When the setting wizard button 27e is operated by the user, the controller 10 functions as an input receiving unit 31, a setting item specifying unit 32, a screen generating unit 33, and a screen providing unit 34. These units function when the processor 11 executes the program 20.

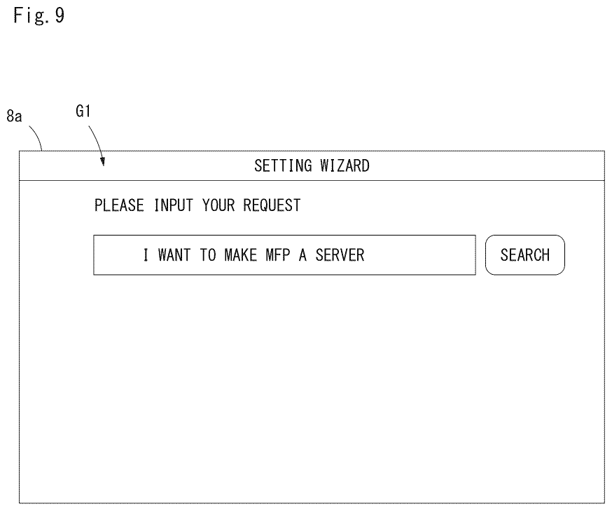

The input receiving unit 31 displays an initial screen of the setting wizard on the display part 8a, and accepts input from the user. FIG. 9 is a diagram illustrating an initial screen G1 displayed on the display part 8a. When the initial screen G1 is displayed on the display part 8a, the input receiving unit 31 inputs the user's request in text. For example, the user may not understand what kind of setting should be performed for the additional function of the information processing apparatus 2. Therefore, the input receiving unit 31 receives the user's request in a natural language format. Therefore, the user can input his/her request to the information processing system 1 by inputting a message such as “I want to make the MFP a server”.

Note that the input receiving unit 31 may be able to accept not only a text input by the user but also a voice input by the user. When the voice is input, the input receiving unit 31 performs voice recognition and generates text representing the user's request. Therefore, even in the case of a voice input, the input receiving unit 31 acquires text representing the user's request.

When the text indicating the user's request is acquired by the input receiving unit 31, the setting item specifying unit 32 functions in the controller 10. The setting item specifying unit 32 detects a user's request based on the input text, and specifies a setting item to be set by the user from among a plurality of setting items. For example, the setting item specifying unit 32 specifies a setting item to be set by the user in cooperation with the server device 3.

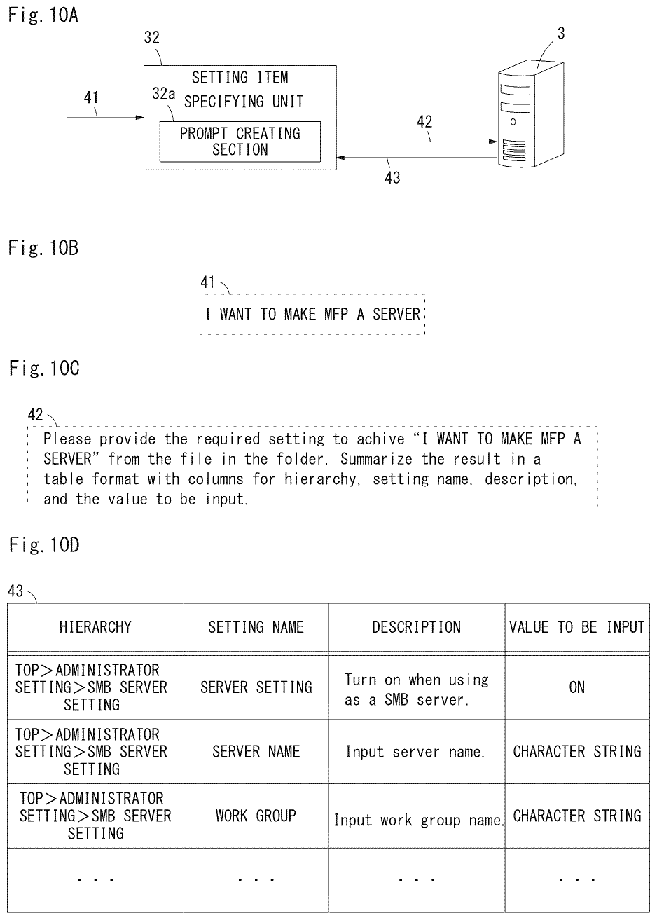

FIG. 10A, FIG. 10B, FIG. 10C, and FIG. 10D are diagrams illustrating configuration examples and operation examples of the setting item specifying unit 32. For example, as illustrated in FIG. 10A, the setting item specifying unit 32 includes a prompt creating section 32a. The prompt creating section 32a creates a prompt 42 to be submitted to the generative AI, based on the text 41 accepted by the input receiving unit 31. The diagram 10B illustrates an example of the text 41, and the diagram 10C illustrates an example of the prompt 42. For example, the prompt creating section 32a generates the prompt 42 in which the text 41 is embedded at a predetermined position of a predetermined character string. The predetermined character string is a character string that enables the generative AI to identify the setting item necessary for performing the setting in accordance with the user's request. By embedding the text 41 in the predetermined character string, the prompt creating section 32a can create the optimum prompt 42 to be submitted to the generative AI. Upon creating the prompt 42, the setting item specifying unit 32 sends the prompt 42 to the server device 3.

The server device 3 holds the same setting item database 23 as the information processing apparatus 2. In response to the input of the prompt 42, the server device 3 extracts, from the setting item database 23, setting items required for making settings in accordance with the user's request, and generates a response 43 in the form of a table as illustrated in FIG. 10D. The server device 3 outputs the response 43 to the setting item specifying unit 32. The setting item specifying unit 32 analyzes the response 43 obtained from the server device 3 and identifies a setting item corresponding to the setting name from the screen at the level specified in the response 43. That is, the setting item specifying unit 32 uses the generative AI provided by the server device 3 to identify the setting item required for performing the setting in accordance with the user's request. Note that the setting item specifying unit 32 may have a built-in function of the server device 3 as described above.

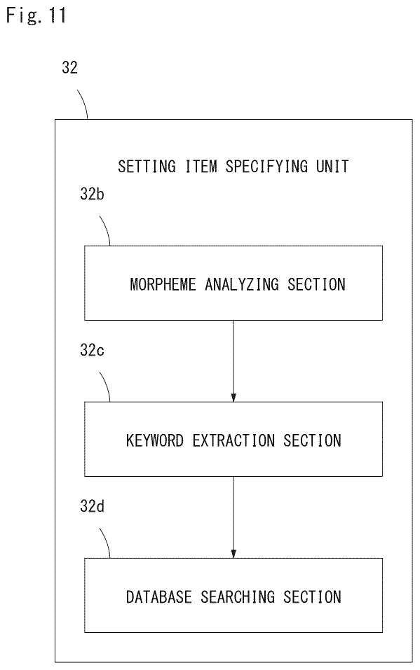

FIG. 11 is a diagram illustrating another configuration example of the setting item specifying unit 32. The setting item specifying unit 32 illustrated in FIG. 11 includes a morpheme analyzing section 32b, a keyword extraction section 32c, and a database searching section 32d.

A morpheme analyzing section 32b divides a text 41 showing the request of a user inputted in a natural language form into morphemes of a minimum unit and discriminates the part of speech or the like of each morpheme. A keyword extraction section 32c extracts a keyword expressing the request of the user from the morpheme discriminated by the morpheme analyzing section32b. For example, the keyword extraction section 32c extracts a keyword that matches a keyword registered in the keyword area 23a of the setting item database 23 from morphemes extracted from the text 41. A database searching section 32d specifies a setting item to be set by a user by retrieving a setting item database 23 based on the keyword extracted by the keyword extraction section 32c.

The screen generating unit 33 generates a setting screen on which the input form of the setting item to be set by the user is arranged based on the specifying result by the setting item specifying unit 32. For example, the screen generating unit 33 identifies the type of input form corresponding to the setting item identified by the setting item specifying unit 32. Then, the screen generating unit 33 reads the input form corresponding to the specified type from the input form 22, and arranges the input form in the screen to generate the setting screen.

The screen providing unit 34 provides the setting screen generated by the screen generating unit 33. For example, the screen providing unit 34 allows the display part 8a to display a setting screen. Thus, the user can perform a setting operation on the setting screen. The screen providing unit 34 may provide the setting screen to the terminal device 5 and cause the terminal device 5 to display the setting screen.

For example, as illustrated in FIG. 9, it is assumed that the user has input the text 41 “I want to make the MFP a server”. In this case, the keyword extraction section 32c extracts the keyword 231 of “server”. A keyword 231 “server” is registered in the keyword area 23a of the setting item database 23 illustrated in FIG. 5. The keyword 231 “server” is associated with the plurality of setting categories 241, 242, and 243 as illustrated in FIG. 5. That is, the information processing apparatus 2 has three setting categories 241, 242, and 243 as setting categories related to the server function. The setting category 241 is a setting category related to “SMB server setting”. The setting category 242 is a setting category related to “FTP server setting”. The setting category 243 is a setting category related to “LDAP server setting”. Therefore, even if the setting item specifying unit 32 searches the setting item database 23, the setting item specifying unit 32 cannot specify one setting category that satisfies the user's request. In this way, when a plurality of setting categories are detected by the setting item specifying unit 32, the screen generating unit 33 generates a selection screen for selecting one setting category from the plurality of setting categories. In this case, the screen providing unit 34 displays the selection screen generated by the screen generating unit 33 on the display part 8a, and receives a selection operation by the user.

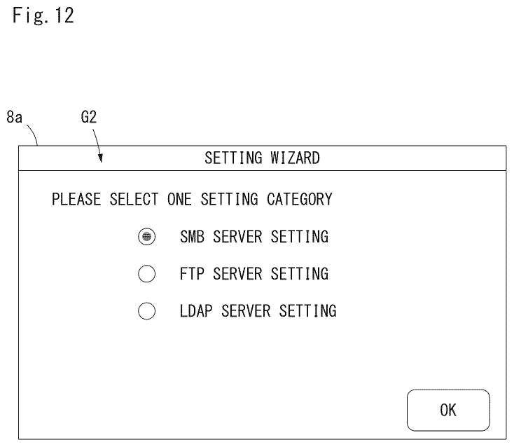

FIG. 12 is a view illustrating an example of the selection screen G2. The selection screen G2 is a screen for selecting one of a plurality of setting categories detected based on a keyword indicating a user's desire. The example illustrated in FIG. 12 has a screen configuration in which one of three options, that is, SMB server setting, FTP server setting, and LDAP server setting can be selected. The screen generating unit 33 generates a selection screen G2 on which radio buttons 22b for selecting one of the three options are arranged. Note that FIG. 12 illustrates a state in which the SMB server setting is selected. By displaying such a selection screen G2, the user can specifically instruct the information processing apparatus 2 what the user wants to do. Then, the setting item specifying unit 32 specifies one setting category corresponding to the user's request based on the user's operation on the selection screen G2.

When one setting category is specified, the setting item specifying unit 32 searches the category detailed information 23c. Then, the setting item specifying unit 32 extracts all the setting items registered in the specified one setting category from the category detailed information 23c. That is, the setting item specifying unit 32 extracts all the setting items to be set by the user in the specified setting category. Thus, at least one setting item is extracted. Then, the setting item specifying unit 32 notifies the screen generating unit 33 of the setting item to be set by the user in the specified setting category.

The setting item specifying unit 32 also determines whether another setting category is linked to the identified one setting category by the edges 251 and 252. When another setting category is linked by the edges 251 and 252, the setting item specifying unit 32 further identifies another setting category linked by the edges 251 and 252. Then, the setting item specifying unit 32 also extracts a setting item from the specified different setting category. Then, the setting item specifying unit 32 notifies the screen generating unit 33 of the setting item extracted from the other setting category.

The screen generating unit 33 generates a screen having a number of pages corresponding to the number of setting categories identified by the setting item specifying unit 32. For example, when two setting categories are associated with each other by the edges 251 and 252, the screen generating unit 33 generates a setting screen for two pages.

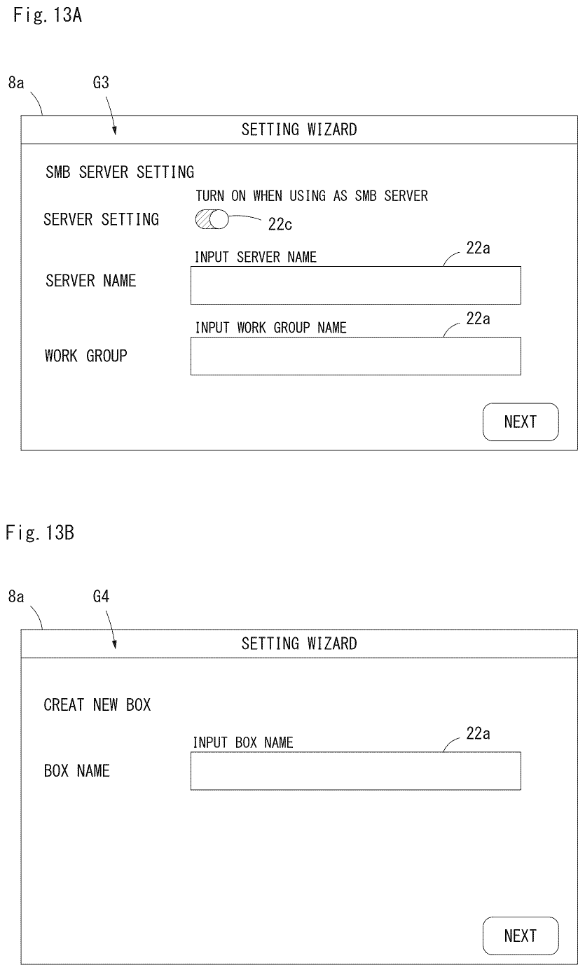

FIG. 13A and FIG. 13B are diagrams illustrating the two setting screens G3 and G4 generated for the SMB server setting. FIG. 13A illustrates a setting screen G3 for SMB server setting. For example, as illustrated in the 13A of the drawing, the setting screen G3 for SMB server setting includes, as setting items, “server setting”, “server name”, and “work group”.

Under the setting item “server setting”, a toggle switch 22c for switching on and off the server setting is displayed as the input form 22. Therefore, the user can turn on the server setting by performing a switching operation on the toggle switch 22c.

Furthermore, when generating the setting screen G3, the screen generating unit 33 acquires, from the category detailed information 23c, a recommended value for the setting item “server setting”. When the setting item of “server setting” is arranged on the setting screen G3, the screen generating unit 33 reflects the recommended value on the toggle switch 22c. For example, when it is necessary to set the toggle switch 22c to the ON state in order to reflect the setting according to the request of the user, the screen generating unit 33 displays the toggle switch 22c in the display mode of the ON state. Thus, the user does not needs to perform a switching operation on the setting item “server setting”. As a result, it is possible to prevent a setting omission or a setting mistake by the user.

Furthermore, when generating the setting screen G3, the screen generating unit 33 acquires, from the category detailed information 23c, a description on the setting item of “server setting”. When the setting item of “server setting” is arranged on the setting screen G3, the screen generating unit 33 arranges and displays a description thereof in the vicinity of the toggle switch 22c. Therefore, the user can grasp what kind of setting should be performed by reading the displayed description. Therefore, it is possible to prevent a setting omission or a setting error by the user.

In the setting item of “server name”, a character string input form 22a is displayed as the input form 22. Therefore, the user can set a server name by performing an input operation of a character string in the character string input form 22a.

When generating the setting screen G3, the screen generating unit 33 may acquire a recommended value or a default value related to the setting item of “server name” and display the recommended value or the default value in the character string input form 22a in advance. Further, when generating the setting screen G3, the screen generating unit 33 may execute a setting value acquiring function related to the setting item of “server name”, and may display the current setting value in the information processing apparatus2 in the character string input form 22a in advance. When generating the setting screen G3, the screen generating unit 33 can reduce the operation burden on the user by displaying a pre-specified character string in the character string input form 22a. A description is also displayed for the setting item of “server name” in the same manner as described above.

In the setting item of “work group”, a character string input form 22a is displayed as the input form 22. Therefore, the user can set the name of a work group by performing an input operation of a character string in the character string input form 22a.

When generating the setting screen G3, the screen generating unit 33 may acquire a recommended value or a default value related to the setting item of the “work group” and display the recommended value or the default value in the character string input form 22a in advance. Further, when generating the setting screen G3, the screen generating unit 33 may execute a setting value obtaining function related to the setting item of the “work group” and display the current setting value in the information processing apparatus 2 in the character string input form 22a in advance. Also in this case, the screen generating unit 33 can reduce the operation burden on the user. Note that a description is also displayed for the setting item “work group” in the same manner as described above.

When finishing the setting operation on the setting screen G3, the user operates a “Next” button displayed at the lower right of the setting screen G3. Then, the screen providing unit 34 changes the screen of the display part 8a from the setting screen G3 of the FIG. 13A to the setting screen G4 of the FIG. 13B. FIG. 13B illustrates a setting screen G4 for newly creating a BOX associated with SMB server setting. The setting screen G4 includes “BOX name” as a setting item.

In the setting item of “BOX name”, a character string input form 22a is displayed as the input form 22. Therefore, the user can set a BOX name by performing an input operation of a character string in the character string input form 22a. Note that when generating the setting screen G4, the screen generating unit 33 may acquire a recommended value or a default value for the setting item “BOX name” and display it in the character string input form 22a in advance. The screen generating unit 33 can reduce the operation burden on the user by displaying the pre-specified character string in the character string input form 22a. Note that a description is also displayed for the setting item “BOX NAME” in the same manner as described above. When finishing the setting operation on the setting screen G4, the user operates a “Next” button displayed at the lower right of the setting screen G4.

In a case where no screen exists subsequent to the setting screen G4, all setting operations by the user will be completed. In this case, the controller 10 reflects the value input by the user for each setting item included in the setting screens G3 and G4 in the information processing apparatus 2, and operates the function desired by the user.

### Processing Procedure

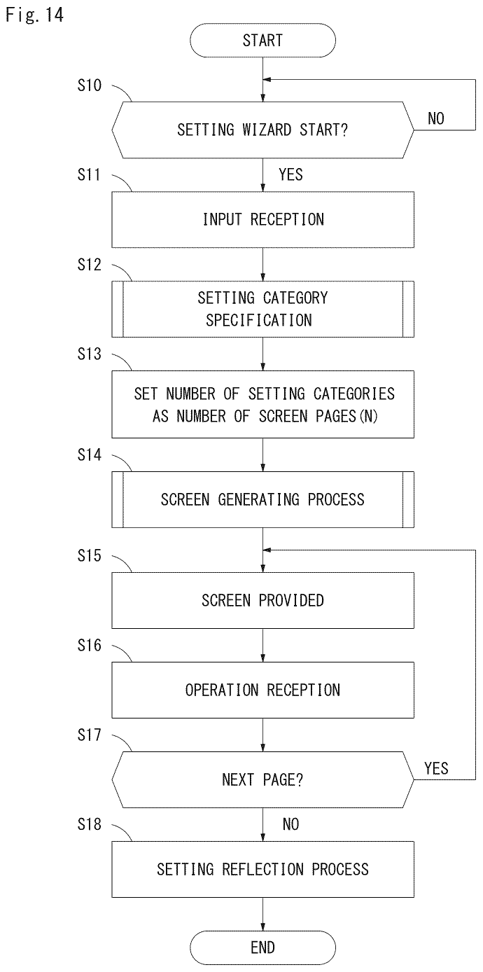

FIGS. 14 to 16 are flowcharts illustrating an example of a processing procedure in the information processing system 1. This process is mainly performed by the processor 11 of the controller 10 executing the program 20. The controller 10 determines whether the user has issued an instruction to start the setting wizard (step S10). For example, when the top screen 26a shown in FIG. 7 is displayed, if the setting wizard button 27e is operated by the user, the controller 10 detects an instruction to start the setting wizard by the user.

When an instruction to start the setting wizard is detected (YES in step S10), the controller 10 displays an initial screen G1 (see FIG. 9) of the setting wizard, and receives an input from the user (step S11). Upon receiving the user's input, the controller 10 executes setting category specifying processing (step S12).

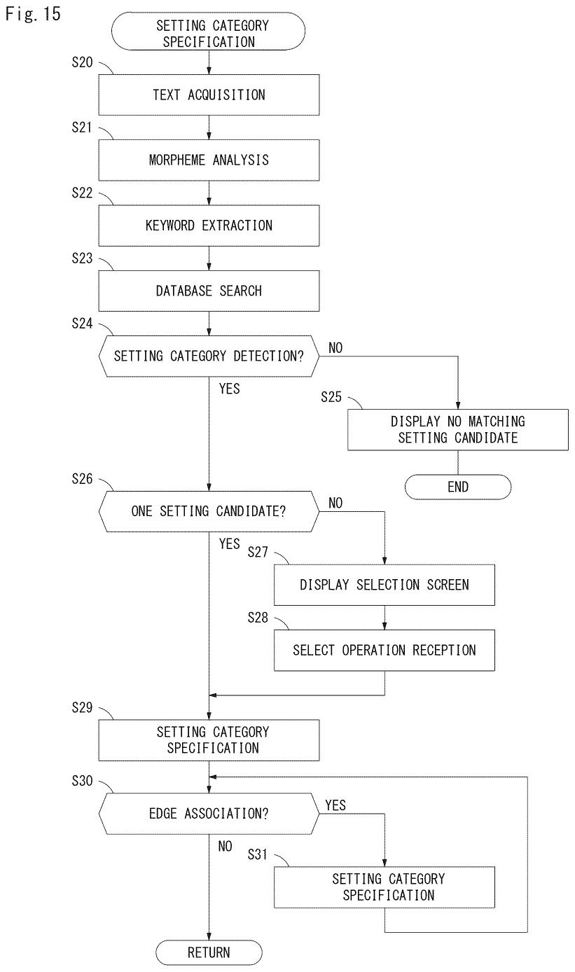

FIG. 15 is a flowchart illustrating a specific processing procedure of the setting category identification processing. First, the controller 10 acquires the text 41 indicating the user's request (step S20). Upon acquiring the text 41, the controller 10 performs morphological analysis on the text 41 (step S21), and extracts, from the text 41, a keyword representing a user's request (step S22). The controller 10 searches the setting item database 23 based on the extracted keyword, and detects a setting category corresponding to the keyword (step S23).

The controller 10 determines whether a setting category to be a setting candidate has been detected by the search processing of the setting item database 23 (step S24). If a setting category as a setting candidate cannot be detected (NO in step S24), the controller 10 displays a screen indicating that a setting candidate corresponding to the keyword has not been found (step S25). In this case, the controller 10 cannot proceed with the setting process according to the user's request. Therefore, the processing by the controller 10 ends.

On the other hand, when a setting category as a setting candidate can be detected (YES in step S24), the controller 10 determines whether or not the number of setting candidates corresponding to the keyword is one (step S26). That is, the controller 10 determines whether the number of setting categories associated with the keyword in the setting item database 23 is one. If a plurality of setting categories are associated with the keyword (NO in step S26), the controller 10 displays a selection screen G2 as shown in FIG. 12 (step S27). The selection screen G2 is a screen for selecting one category from a plurality of setting categories. Next, the controller 10 receives a selection operation by the user (step S28). Next, the controller 10 identifies a setting category corresponding to the keyword (step S29).

Next, the controller 10 determines whether the identified setting category is linked to another setting category by an edge (step S30). If there is another associated setting category (YES in step S30), the controller 10 follows the edge and specifies the other setting category (step S31). Thereafter, the process by the controller 10 returns to step S30, and determines whether another setting category is further associated with the identified another setting category. Therefore, the controller 10 can specify a plurality of setting categories according to the setting order by repeatedly executing the processing from step S30 to step S31. Then, when there is no longer any edge association, the setting category identification processing ends.

Return to the flowchart of FIG. 14. The controller 10 sets the number of setting categories identified in the setting category identification processing (step S12) as the number N of screen pages (step S13). Next, the controller 10 performs screen generation processing (step S14).

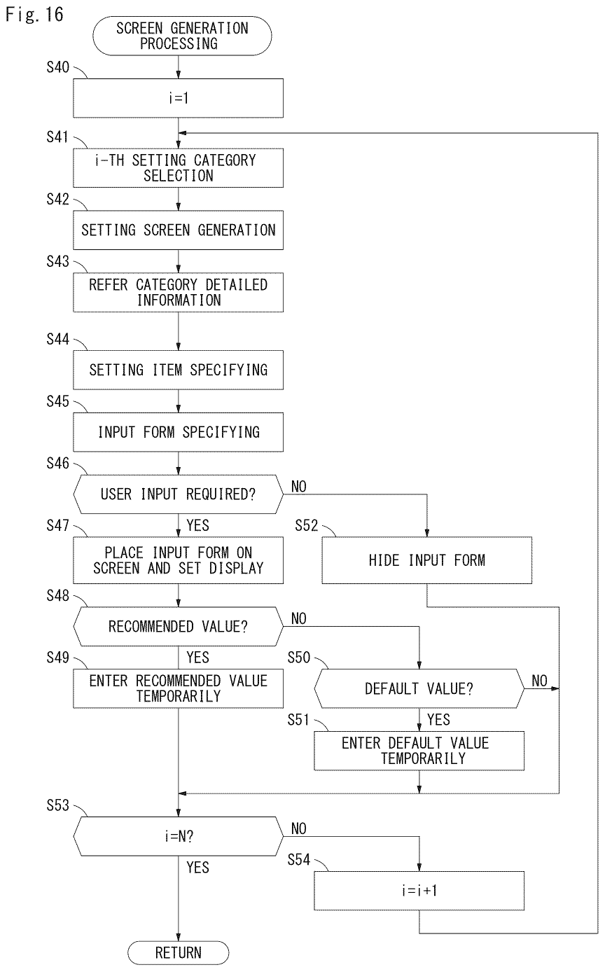

FIG. 16 is a flowchart illustrating an example of the detailed processing procedure of the screen generation processing (step S14). When starting this processing, the controller 10 initializes a variable I to 1 (step S40). Next, in the setting category identification processing (step S12), the controller 10 selects the i-th identified setting category (step S41). The controller 10 generates an i-th setting screen (step S42). Next, the controller 10 refers to the category detailed information 23c (step S43). Based on the category detailed information 23c, the controller 10 identifies the setting items included in the i-th setting category (step S44) and further identifies the input form corresponding to the setting items (step S45).

Furthermore, the controller 10 determines, based on the input attribute of the identified setting item, whether an input operation by the user is necessary (step S46). When the input operation by the user is necessary (YES in step S46), the controller 10 arranges the input form specified in step S45 in the setting screen generated in step S42, and gives the display setting to the input form (step S47). For example, when the input form is a cascading style sheets (CSS) file, the controller 10 can give a display setting or a non-display setting to the input form arranged in the screen.

After placing the input form corresponding to a setting item in the screen, the controller 10 determines whether there is a recommended value for the setting item (step S48). When there is a recommended value (YES in step S48), the controller 10 displays the recommended value in a state of being temporarily input in the input form (step S49).

If no recommended value exists (NO in step S48), the controller 10 determines whether or not a default value for the setting item exists (step S50). If there is a default value (YES in step S50), the controller 10 displays the default value in a state of being temporarily input in the input form (step S51).

On the other hand, in a case where the specified setting item does not require the input operation by the user (NO in step S46), the controller 10 assigns the non-display setting to the input form corresponding to the setting item (step S52). Note that the controller 10 may not arrange, in the setting screen, the input form that does not require the input operation by the user.

Through steps S41 to S52 described above, a setting screen for the i-th setting category is generated. This setting screen includes only setting items necessary for achieving the user's request. Therefore, the user does not need to find out, by himself/herself, a necessary setting item from among the plurality of screens formed in the hierarchical structure in order to realize his/her desire. Therefore, the operation burden on the user is significantly reduced.

When the i-th setting screen is generated, the controller 10 determines whether or not the variable I is equal to N (step S53). If the variable I is less than N (NO in step S53), the controller 10 adds 1 to the variable I (step S54). Thereafter, the controller 10 repeatedly executes the processing in steps S41 to S52. Thus, a setting screen for another setting category is generated. Then, when the variable I becomes equal to N (YES in step S53), the screen generation processing ends.

The process returns to the flowchart of FIG. 14 again. Upon generating the setting screens for N pages, the controller 10 first reads the setting screen for the first page and provides it as a screen (step S15). For example, the controller 10 displays the setting screen for the first page on the display part 8a. Then, the controller 10 receives a user's operation on the setting screen of the first page (step S16). When the user's operation on the setting screen of the first page is completed, the controller 10 determines whether or not there is a next page (step S17). If there is a next page (YES in step S17), the process by the controller 10 returns to step S15 and repeats the same processing for the setting screens for the second and subsequent pages. When the user's operation on the setting screens of all the pages is completed (NO in step S17), the controller 10 executes the setting reflection process (step S18). Thus, the setting corresponding to the user's request is reflected in the information processing apparatus 2.

### Advantage

As described above, the information processing system 1 of the present embodiment includes the input receiving unit 31, the setting item specifying unit 32, the screen generating unit 33, and the screen providing unit 34. The input receiving unit 31 receives a text input of a user's request regarding the setting. The setting item specifying unit 32 detects a user's request based on the input text, and specifies a setting item to be set by the user from among a plurality of setting items. A screen generating unit 33 generates a setting screen on which an input form corresponding to the specified setting item is arranged. The screen providing unit 34 provides the setting screen generated by the screen generating unit 33 in a manner that can be operated by the user.

According to such an information processing system 1, when a user's request is input as text, a setting screen in which setting items necessary for achieving the request are arranged is automatically generated. Therefore, the user does not have to search for a screen in which necessary setting items are arranged from among a plurality of screens having a complicated hierarchical structure. Therefore, the information processing system 1 can prevent a setting omission or a setting mistake by the user.

Furthermore, the information processing system 1 automatically displays a setting screen in response to a text input of a user's request. Therefore, it is not necessary to install in advance, in the information processing apparatus 2, wizard format setting screens corresponding to all of the diversified user's demands. Therefore, according to the information processing system 1, it is possible to reduce the development cost of the setting screen.

### Modification Example

A preferred embodiment of the present invention has been described above. However, the present invention is not limited to the content described in the above embodiment, and various modification examples are applicable.

For example, in the above-described embodiment, the case where the information processing apparatus 2 is an MFP has been exemplified. However, the information processing apparatus 2 is not limited to one configured as an MFP.

Furthermore, the above embodiment is described with the example in which the program 20 to be executed by the processor 11 of the controller 10 is stored in the storage section 13 in advance. However, the program 20 itself may be a target of trading. Therefore, the program 20 may be a program that is installed in the information processing apparatus 2 as necessary. In this case, the program 20 is provided in a downloadable form via a network such as the Internet, for example. In other case, the program 20 is provided in a form recorded on a non-transitory computer-readable recording medium such as a CD-ROM or a USB memory, for example. Furthermore, the program 20 may be provided in any other manner.

Although embodiments of the present invention have been described and illustrated in detail, the disclosed embodiments are made for purposes of illustration and example only and not limitation. The scope of the present invention should be interpreted by terms of the appended claims.

What is claimed is

1. An information processing system comprising a hardware processor that:
enters a user's request for settings as text;
detects the user's request based on the text;
specifies a setting item to be set by the user from among a plurality of setting items in accordance with the user's request;
generates a setting screen on which an input form corresponding to the specified setting item is arranged; and
provides the generated setting screen.

2. The information processing system according to claim 1, further comprising:
a generative AI server, wherein
the hardware processor submits the text to the generative AI server and identifies the setting item to be set by the user based on a response obtained from the generative AI server.

3. The information processing system according to claim 2, wherein
the hardware processor creates a prompt in a predetermined format based on the text and submits the prompt to the generative AI server.

4. The information processing system according to claim 1, further comprising:
a storage section that stores a setting item database in which setting categories obtained by grouping setting items related to each other among the plurality of setting items and keywords assigned to the setting categories are associated with each other, wherein
when the keyword is included in the text, the hardware processor searches the setting item database to extract a setting category to which the keyword is assigned, and identifies a setting item included in the extracted setting category as the setting item to be set by the user.

5. The information processing system according to claim 4, wherein
the setting item database associates a plurality of setting categories related to each other, and in a case where different setting category is associated with the setting category to which the keyword
is assigned, the hardware processor identifies, as the setting items to be set by the user, setting items included in each of the setting category to which the keyword is assigned and the different setting category.

6. The information processing system according to claim 5, wherein
the hardware processor generates, as different screens, a setting screen in which an input form corresponding to a setting item included in the setting category to which the keyword is assigned and a setting screen in which an input form corresponding to a setting item included in the different setting category is arranged, and sequentially provides a plurality of setting screens generated as the different screens.

7. The information processing system according to claim 4, wherein
the setting item database may associate a same keyword with a plurality of setting categories, and when detecting a plurality of setting categories based on the keyword included in the text, the hardware processor generates a selection screen for selecting one of the plurality of setting categories, and selects one of the setting categories selected on the selection screen.

8. The information processing system according to claim 1, wherein
the hardware processor determines a type of a setting input value for the specified setting item, selects an input form corresponding to the type of the setting input value from among a plurality of types of input forms, and arranges the selected input form in the setting screen.

9. The information process system according to claim 8, wherein
the hardware processor selects a character string input form when the type of the setting input value is a character string, selects a radio button or a pull-down menu as the input form when the type of the setting input value is selection from two or more choices, and selects a toggle switch as the input form when the type of the setting input value is switching on or off.

10. The information processing system according to claim 4, wherein
the setting item database holds, for each of a plurality of setting items, a description text related to setting and a default value, and
when generating the setting screen in which the input form corresponding to the specified setting item is arranged, the hardware processor arranges the description text in the setting screen and reflects the default value in the input form.

11. The information processing system according to claim 4, wherein
the setting item database registers an input form corresponding to each of a plurality of setting items, and
the hardware processor identifies an input form corresponding to the identified setting item based on the setting item database, and places the identified input form in the setting screen.

12. The information processing system according to claim 1, wherein
upon identifying a plurality of setting items, the hardware processor determines whether each of the plurality of setting items requires a setting operation by the user, and generates the setting screen in which a setting item that does not require the setting operation by the user set to non-display.

13. A setting screen generating method in an information process system, comprising:
entering a user's request for settings as text;
detecting the user's request based on the text;
specifying a setting item to be set by the user from among a plurality of setting items in accordance with the user's request;
generating a setting screen on which an input form corresponding to the specified setting item is arranged; and
providing the generated setting screen.

14. A non-transitory computer-readable recording medium storing a program causing a computer to perform:
entering a user's request for settings as text;
detecting the user's request based on the text;
specifying a setting item to be set by the user from among a plurality of setting items in accordance with the user's request;
generating a setting screen on which an input form corresponding to the specified setting item is arranged; and
providing the generated setting screen.
